(19) United States
(12) Patent Application Publication
(10) Pub. No.: US 2004/0049959 A1
(43) Pub. Date: Mar. 18, 2004

(54) Overhead hanging clearance bar

(76) Inventor: Frank Venegas JR., Brighton, MI (US)

Correspondence Address: Gifford, Krass, Groh, Sprinkle, Anderson & Citkowski, P.C., Suite 400, 280 N. Old Woodward Ave., Birmingham, MI, 48009-5394, US

(21) Appl. No.: 10/455,196

(22) Filed: Jun. 5, 2003

Related U.S. Application Data
(60) Provisional application No. 60/386,486, filed on Jun. 6, 2002.

(51) Int. Cl. G09F 7/00

(52) U.S. Cl. 40/584

(57) ABSTRACT

An improved clearance bar uses an elongated enclosed, hollow plastic member, and fasteners on either end, permitting the member to be suspended for use. The ends are preferably hemispherical, though other shapes may be used. In the preferred embodiment the enclosed, hollow plastic member is rotationally molded. The bar may further have visual indicia, such as a height restriction, imprinted thereon or included in the mold during manufacture thereof.

### REFERENCE TO RELATED APPLICATION

This application claims priority from U.S. Provisional Patent Application Serial No. 60/386,486, filed Jun. 6, 2002, the entire content of which is incorporated herein by reference.

### FIELD OF THE INVENTION

This invention relates generally to overhead clearance indicators and, in particular, to an improved aesthetically pleasing overhead clearance or “banger bar.”

### BACKGROUND OF THE INVENTION

Given that a vehicle having excessive height could cause a great deal of damage entering a building or other structure with a low overhead clearance, it is not uncommon to have hanging clearance bars outside of parking structures, and the like. Currently, such clearance bars are fabricated from a hollow tube of plastic material such as PVC, which exhibits various shortcomings. For one, PVC is only available in limited number of colors, such that color-coordinating with the surroundings is difficult without applying paint or some other coating. Even then, should vehicles strike the device, the paint or coating flakes or peels off, resulting in poor appearance. In addition, since the ends are open, birds often nest in the tube, also creating an undesirable appearance. Accordingly, the need remains for an improved clearance bar which solves these problems.

### SUMMARY OF THE INVENTION

This invention resides in an improved clearance bar. The preferred embodiment includes an elongated enclosed, hollow plastic member, and fasteners on either end permitting the member to be suspended for use. The ends are preferably hemispherical, though other shapes may be used.

In the preferred embodiment the enclosed, hollow plastic member is rotationally molded. The bar may further have visual indicia, such as a height restriction, imprinted thereon or included in the mold during manufacture thereof.

### BRIEF DESCRIPTION OF THE DRAWINGS

FIG. 1 illustrates a preferred embodiment according to the invention; and

FIG. 2 shows one way to attach suspension means according to the invention, namely, the use of a single hole on either end with threaded insert, to which a screw eye is then inserted.

### DETAILED DESCRIPTION OF THE INVENTION

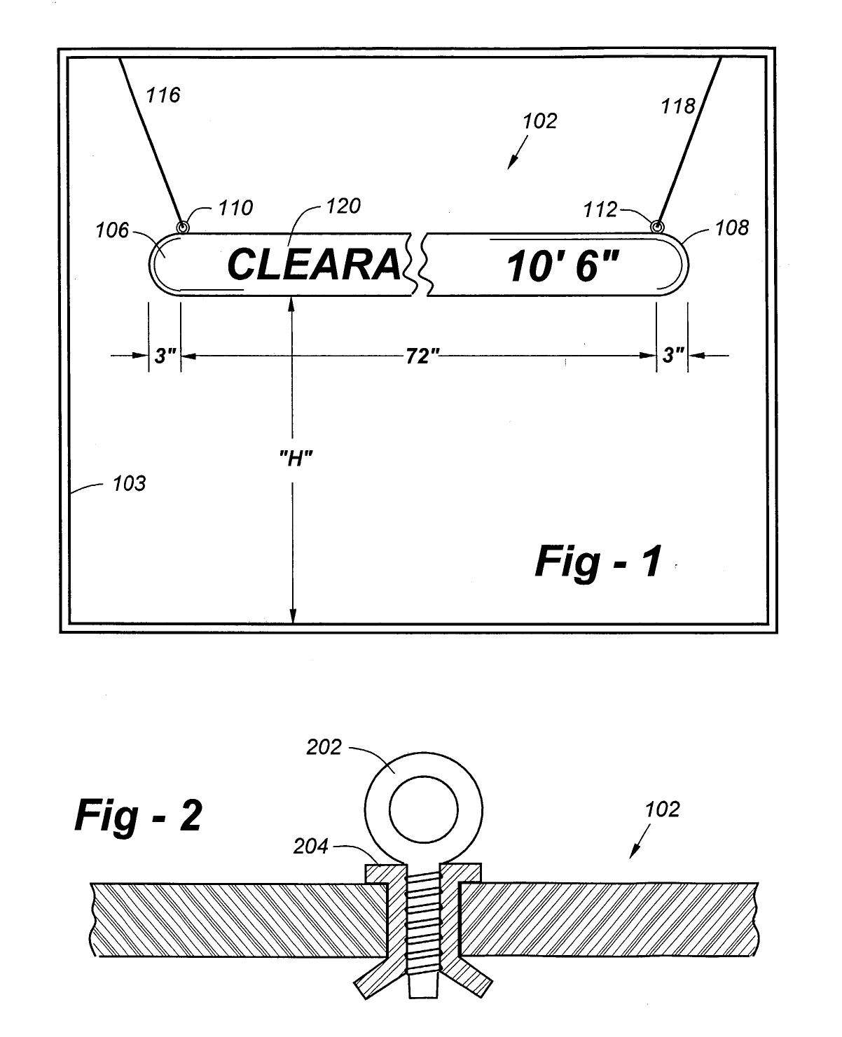

This invention overcomes the shortcomings of the prior art by providing a clearance bar or banger bar, having closed ends and which can be provided in any color. As shown in FIG. 1, the invention provides an elongated generally cylindrical member 102, preferably having hemispherically closed ends 106, 108 with attachment points 110, 122 facilitating suspension by chains 116, 118, ropes, or other elements at a desired height “H” above a lower surface. The dimensions (78″ total length and 6″ diameter) are typical, and such sizes may vary in accordance with the application.

In the preferred embodiment, a rotational mold is used resulting in an encapsulated but hollow structure which is then drilled to provide attachment point. It will be appreciated to one of skill in the art that other molding processes may be used, such as blow molds, and the like. However, in the preferred embodiment, a rotational mold is used to achieve a comprise involving volume, production costs, surface quality, appearance, and so forth.

FIG. 2 shows one way to attach the suspension means, namely, the use of a single hole on either end with threaded insert 204, to which a screw eye 202 is then inserted. In an alternative embodiment, a hole is drilled entirely through opposing surfaces of the molded unit, requiring the use of a longer fastener and nut on the bottom end. One advantage of the configuration of FIG. 2 is that the bottom of the bar remains smooth in the event that a vehicle comes underneath, it would not be scratched if it made contact.

The information 120 shown on the horizontal member may be provided in different ways, including decals, silk screening or inclusion right in the mold, which is common with the rotational molding process. Although the decorative feature of the hemispherical ends is not essential to the invention, it is preferred in terms of an ornamental look and, once removed from the mold, the article may be cut in half to form two sleeves of the type provided in co-owned U.S. Pat. No. D465,585.

I claim:

1. A clearance bar comprising:
an elongated, enclosed hollow plastic member; and
fasteners on either end permitting the member to be suspended for use as a clearance bar or banger bar.

2. The clearance bar of claim 1, wherein the element is rotationally molded.

3. The clearance bar of claim 1, further including visual indicia included in the mold during manufacture thereof.

4. The clearance bar of claim 1, wherein the ends are hemispherical.

5. The clearance bar of claim 1, wherein the fasteners affect only one surface of the member, such that an opposing surface remains smooth to minimize harm to vehicles or objects passing therebeneath.
